(19) United States
(12) Patent Application Publication
(10) Pub. No.: US 2023/0201056 A1
(43) Pub. Date: Jun. 29, 2023

(54) REMOVABLE ELECTRIC PROPULSION SYSTEM FOR A ROLLING OBJECT WITH A MEANS FOR COMBINED AND SIMULTANEOUS GRIPPING AND LIFTING

(71) Applicant: IFP Energies nouvelles, RUEIL-MALMAISON (FR)

(72) Inventors: Stephane VENTURI, RUEIL-MALMAISON CEDEX (FR); Bertrand LECOINTE, RUEIL-MALMAISON CEDEX (FR)

(21) Appl. No.: 17/927,098

(22) PCT Filed: May 5, 2021
(86) PCT No.: PCT/EP2021/061866

§ 371 Date: Nov. 22, 2022

(30) Foreign Application Priority Data
May 29, 2020 (FR) 2005678

(51) Int. Cl. A61G 7/08; B62B 3/06; B62B 3/12; B62B 5/00

(52) U.S. Cl. CPC A61G 7/08; B62B 3/06; B62B 3/12; B62B 5/0043; B62B 5/0079; B62B 2202/30; B62B 2202/031; B62B 2203/07; B62B 2203/10

(57) ABSTRACT

The present invention relates to a removable electric propulsion system intended to be coupled to a rolling object. The propulsion system comprises a chassis provided with at least one wheel driven by an electric machine, and at least one non-driven wheel. Furthermore, the system, preferably the chassis, comprises means (5) for coupling the propulsion system to the rolling object. Besides, the coupling means comprises at least one means (100) providing combined and simultaneous gripping and lifting of at least one wheel (14) of the rolling object, preferably of two wheels (14) of the rolling object.

The invention also relates to a method for coupling a rolling object to such a propulsion system, this method enabling, simultaneously and through a combined action, gripping and lifting of at least one wheel (14) of the rolling object.

### FIELD OF THE INVENTION

The invention relates to the field of transport of rolling objects, for example rolling beds such as hospital beds, and more specifically wheelchairs.

Moving rolling heavy loads can lead to difficulties for users, in particular if this action is repeated, such as musculoskeletal disorders.

### BACKGROUND OF THE INVENTION

In order to make moving of heavy rolling loads easier and more ergonomic, it has been considered to equip these heavy loads with electric machines. For example, a first idea has consisted in providing each hospital bed with an electric wheel drive system. Such a solution is expensive because it requires changing or modifying all the beds, which hospitals cannot afford. Furthermore, the drive system and the battery increase the weight of the bed. Therefore, when the battery is discharged, the effort required to move the bed is greater.

Similarly, in the field of logistics or trade, it has been envisaged to make all trolleys electric. Again, such a solution is expensive.

One alternative is to provide a removable propulsion system for rolling objects. Several technical solutions have been considered.

For example, patent application WO-01/85,086 describes a motorized propulsion system for a bed. The propulsion system is configured for coupling to one or more points of the bed. Due to the coupling means provided for this propulsion system, this system cannot be universal and suitable for different rolling objects. Indeed, it cannot be coupled to a rolling object not provided with a coupling part. In addition, for this propulsion system, all the wheels of the rolling object remain in contact with the ground. Therefore, the orientation of the coupled assembly (propulsion system and bed) is more complicated, the frictional forces are high and the motorized wheel requires more power.

Patent application WO-2012/171,079 describes a second propulsion system for a hospital bed. The propulsion system is configured to lift two wheels of the bed. However, the wheel gripping mechanism is complex and bulky: the lateral dimension (direction parallel to the axis of the motorized wheels) is great (greater than the width of the bed wheels) and it can exceed the lateral dimensions of the bed, which may be inconvenient for moving the bed, in particular in a reduced space such as a hospital corridor or lift.

Patent application WO-2013/156,030 describes a third propulsion system for a hospital bed. The propulsion system is configured to lift two wheels of the bed. However, the lifting system requires several actuators. It is therefore complex.

In order to solve the problems of the prior art, the invention aims to provide a system adaptable to various rolling objects, with a simple, fast and inexpensive coupling system.

The present invention therefore relates to a removable electric propulsion system intended to be coupled to a rolling object. The electric propulsion system comprises a chassis provided with at least one wheel driven by an electric machine, and at least one non-driven wheel. Besides, the electric propulsion system, preferably the chassis, comprises means for coupling the propulsion system to the rolling object. Furthermore, the coupling means comprises at least one means for combined and simultaneous gripping and lifting of at least one wheel of the rolling object.

### SUMMARY OF THE INVENTION

The invention relates to a removable electric propulsion system for a rolling object, said propulsion system comprising a chassis provided with at least one wheel driven by an electric machine and at least one non-driven wheel, said electric propulsion system comprising at least one means for coupling said electric propulsion system to said rolling object. Furthermore, said coupling means comprises at least one means for combined and simultaneous gripping and lifting of at least one wheel of said rolling object.

Advantageously, said combined and simultaneous gripping and lifting means comprises at least one frame connected to the chassis and at least one tilt element capable of supporting the wheel of the rolling object, said frame being connected by a first pivot connection of substantially horizontal axis to at least one tilt element.

Preferably, said combined and simultaneous gripping and lifting means comprises at least two tilt elements, said tilt elements being connected to each other, two by two, through substantially horizontal and parallel pins.

According to a variant of the invention, said combined and simultaneous gripping and lifting means comprises at least one device for limiting the angular clearance of at least one tilt element.

Advantageously, said combined and simultaneous gripping and lifting means comprises at least one holding piece for holding at least one tilt element in raised position.

According to a configuration of the invention, at least one tilt element comprises a guide piece for orienting the wheel of the rolling object in said tilt element comprising said guide piece.

According to an implementation of the invention, at least one tilt element comprises a means for adjusting the width of said tilt element, said means for adjusting the width of said tilt element being preferably a mobile flange or a shim.

Preferably, the electric propulsion system comprises two combined and simultaneous gripping and lifting means, each combined and simultaneous gripping and lifting means comprising a distinct actuator.

According to an embodiment of the invention, said combined and simultaneous gripping and lifting means is configured to simultaneously achieve gripping and lifting of at least two wheels of the rolling object, said at least two wheels of the rolling object being preferably positioned on a substantially transverse axis to said electric propulsion system.

Advantageously, said combined and simultaneous gripping and lifting means comprises at least one means enabling movement in the transverse direction of said combined and simultaneous gripping and lifting means, the transverse direction being orthogonal to the longitudinal direction, the longitudinal direction being the principal direction of travel of said removable electric propulsion system.

Preferably, said combined and simultaneous gripping and lifting means comprises a guide element for orienting the wheel of the rolling object in a direction close to a substantially perpendicular direction to the longitudinal direction of said chassis of said propulsion system, before said wheel of the rolling object is gripped and lifted.

Advantageously, said combined and simultaneous gripping and lifting means comprises a first stop for immobilizing the rolling object.

According to a variant of the invention, the combined and simultaneous gripping and lifting means comprises a raising device configured to ensure a ground clearance greater than a predetermined height in raised position, preferably the predetermined height being at least 40 mm.

Preferably, the raising device comprises at least one return spring and/or at least one counterweight and/or at least one driven rod.

According to an advantageous configuration of the invention, the combined and simultaneous gripping and lifting means comprises an adjustment means in longitudinal position.

The invention also relates to a coupled assembly comprising a rolling object and an electric propulsion system according to one of the above features, said rolling object being coupled to said electric propulsion system by said coupling means.

Furthermore, the invention relates to a method for coupling a rolling object to the electric propulsion system as described above, comprising the following steps:
a) moving the electric propulsion system longitudinally so as to bring the combined and simultaneous gripping and lifting means close to at least one wheel of the rolling objet,
b) moving the combined and simultaneous gripping and lifting means or the electric propulsion system in the transverse direction so as to enable contact between the wheel of the rolling object and the combined and simultaneous gripping and lifting means, and
c) continuing the motion in the transverse direction so as to enable combined and simultaneous gripping and lifting of at least one wheel of the rolling object.

### BRIEF DESCRIPTION OF THE FIGURES

Other features and advantages of the system and of the method according to the invention will be clear from reading the description hereafter of embodiments given by way of non-limitative example, with reference to the accompanying figures wherein:

FIG. 1 is a top view of an electric propulsion system according to a first embodiment of the invention,

FIG. 2 is a side view of an electric propulsion system according to a first variant embodiment of the invention,

FIG. 3 is a side view of an electric propulsion system according to a second variant embodiment of the invention,

FIG. 4 is a top view of an electric propulsion system according to an embodiment, coupled to a rolling object according to the invention,

FIG. 5 illustrates a first embodiment of a combined and simultaneous gripping and lifting means of a propulsion system according to the invention, and its associated gripping and lifting method,

FIG. 6A illustrates a second embodiment of a combined and simultaneous gripping and lifting means of a propulsion system according to the invention, and its associated gripping and lifting method,

FIG. 6B illustrates a third embodiment of a combined and simultaneous gripping and lifting means of a propulsion system according to the invention, and its associated gripping and lifting method,

FIG. 7A illustrates a fourth embodiment of a combined and simultaneous gripping and lifting means of a propulsion system according to the invention, and its associated gripping and lifting method,

FIG. 7B illustrates a fifth embodiment of a combined and simultaneous gripping and lifting means of a propulsion system according to the invention, and its associated gripping and lifting method,

FIG. 8 illustrates, in top view, a propulsion system with a combined and simultaneous gripping and lifting means of the invention,

FIG. 9 shows, in top view, the various steps allowing coupling of the rolling object to the propulsion system with a combined and simultaneous gripping and lifting means,

FIG. 10 illustrates a variant embodiment of a combined and simultaneous gripping and lifting means of a propulsion system according to the invention,

FIG. 11a illustrates another variant of a combined and simultaneous gripping and lifting means of a propulsion system according to the invention, in a position enabling gripping of a wheel of the rolling object,

FIG. 11b illustrates another variant of a combined and simultaneous gripping and lifting means of a propulsion system according to the invention, in an intermediate position,

FIG. 12a illustrates a configuration of an embodiment of a combined and simultaneous gripping and lifting means of a propulsion system according to the invention, with a raising device in rest position,

FIG. 12b illustrates a configuration of an embodiment of a combined and simultaneous gripping and lifting means of a propulsion system according to the invention, with a raising device in rest position shown in dotted line and in raised position shown in solid line,

FIG. 13 illustrates the force to be applied onto the combined and simultaneous gripping and lifting means and the elevation of the wheel of the rolling object, according to the motion applied, for a first embodiment of the system comprising a single tilter,

FIG. 14 illustrates the force to be applied onto the combined and simultaneous gripping and lifting means and the elevation of the wheel of the rolling object, according to the motion applied, for a second embodiment of the system comprising two tilters,

FIG. 15 illustrates the force to be applied onto the combined and simultaneous gripping and lifting means and the elevation of the wheel of the rolling object, according to the motion applied, for a third embodiment of the system comprising two tilters and a device for limiting the angular clearance of one of the two tilters,

FIG. 16 illustrates a variant embodiment of a combined and simultaneous gripping and lifting means of a propulsion system according to the invention, and

FIG. 17 is a top view of an electric propulsion system comprising two combined and simultaneous gripping and lifting means according to the invention.

### DETAILED DESCRIPTION OF THE INVENTION

The invention relates to a removable electric propulsion system for a rolling object. An electric propulsion system is understood to be a removable system for assisting the movement of the rolling object in order to limit the forces required for moving the rolling object. This electric propulsion system comprises at least one electric machine for driving it. A rolling object is an object comprising at least two wheels in order to move it.

The rolling object can have any form, it can notably be a rolling bed, such as those used in hospitals, a wheelchair, a trolley, such as those used for logistics, hospital logistics or commercial logistics (such as a shopping trolley) for example, any rolling furniture. Such a rolling object comprises at least two wheels, preferably three or four. Advantageously, at least one wheel, preferably two wheels of the rolling object are idle wheels, in other words, off-centered wheels orientable around a vertical axis. The rolling object is preferably not motorized.

The electric propulsion system according to the invention comprises:
a chassis provided with at least one motorized wheel, i.e. a wheel driven by an electric machine, and at least one non-motorized wheel, i.e. not driven by an electric machine. Preferably, the chassis comprises at least two non-motorized wheels. For example, a motorized wheel can be arranged at one end of the chassis and two non-motorized wheels can be arranged at the other end of the chassis, the vertical axis of the motorized wheel being preferably placed on the perpendicular bisector of the vertical axes of the non-motorized wheels in top view,
at least one means for coupling the propulsion system to a rolling object, the coupling means comprising at least one means for combined and simultaneous gripping and lifting of at least one wheel of the rolling object, preferably two wheels of the rolling object. In other words, the combined and simultaneous gripping and lifting means is configured to simultaneously grip (grab) and lift at least one wheel of the rolling object, preferably two wheels of the rolling object. A combined and simultaneous gripping and lifting means is understood to be a means allowing to simultaneously grip and lift at least one wheel of the rolling object through a combined action by means of a single actuator such as a cylinder. The combined and simultaneous gripping and lifting means thus comprises a single control simultaneously allowing to grip and lift at least one wheel of the rolling object. In other words, such a combined and simultaneous gripping and lifting means differs:
   on the one hand, from gripping and lifting means comprising two distinct controls: one for gripping and the other for lifting; these means do not enable combined action through a single common control,
   on the other hand, from the gripping and lifting means provided for successive gripping and lifting actions.

Using a combined and simultaneous gripping and lifting means is particularly advantageous. Indeed, by means of a combined gripping and lifting action, the kinematics of coupling the rolling object to the propulsion system is simplified. Moreover, this simplification associated with the simultaneity of the gripping and lifting actions allows coupling to be achieved faster than when dissociating these actions, even partly.

Such a combined and simultaneous gripping and lifting means thus enables simple and fast coupling of any rolling object (since no coupling device is required on the rolling object) on the propulsion system.

Furthermore, since the combined and simultaneous gripping and lifting means uses a single control device (notably a single actuator) to achieve simultaneous and combined gripping and lifting of at least one wheel of the rolling object, the cost associated with the control means and the actuators is reduced. When the propulsion system comprises several combined and simultaneous gripping and lifting means, the propulsion system can comprise a single control means for each combined and simultaneous gripping and lifting means. For example, if the propulsion system comprises two combined and simultaneous gripping and lifting means, each enabling gripping and lifting of a distinct wheel of the rolling object, the system can comprise two control means (two cylinders for example), a single control means for each combined and simultaneous gripping and lifting means. Thus, the cost of the propulsion system is limited, and gripping and lifting of the wheels of the rolling object is simple and fast.

The non-driven wheels of the propulsion system, the driven wheel of the propulsion system and/or those of the rolling object can comprise orientable off-centered wheels.

Orientable off-centered wheels are understood to be off-centered idle wheels orientable around a vertical axis. In other words, these wheels can pivot with respect to the chassis about a vertical orientation axis, and the orientation axis of the wheel is off-centered (non-concurrent) with respect to the vertical orientation axis. Thus, a movement applied to the chassis tends to orient the wheel in the opposite direction to the motion caused by the movement applied to the chassis. The wheels are therefore automatically oriented, thus facilitating the maneuverability of the system.

Preferably, the electric propulsion system can comprise a handlebar enabling handling, motion and orientation of the electric propulsion system by a user.

Coupling of the rolling object to the propulsion system is achieved by at least one wheel of the rolling object, preferably by at least one idle wheel of the rolling object. Therefore, the rolling object does not need to be adapted for the electric propulsion system, which makes the electric propulsion system universal for various rolling objects. Preferably, coupling of the rolling object to the propulsion system can be achieved by two wheels of the rolling object, which simplifies the coupling method and the associated coupling means.

In the rest of the description, the terms “longitudinal”, “transverse”, “horizontal” and “vertical” determine the axes and/or the directions of the system when the system stands on a flat and level ground (i.e. a non-sloping ground, in other words, there is no altitude difference on the ground) and in an operating position.

The longitudinal direction corresponds to the principal direction of travel of the electric propulsion system.

The transverse direction (also referred to as lateral in the rest of the description) is the direction orthogonal to the longitudinal direction of the system in the horizontal plane.

The vertical direction is orthogonal to the horizontal plane of the system.

According to a preferred implementation of the invention, the coupling means comprises two combined and simultaneous gripping and lifting means, each of them being intended for lifting at least one wheel of the rolling object, the two combined and simultaneous gripping and lifting means being connected by a linear actuator (a cylinder for example) allowing the combined and simultaneous gripping and lifting means to be moved closer to or away from one another through a (preferably transverse) translational motion. The actuator enables relative translation (transverse translation for example) of one of the combined and simultaneous gripping and lifting means with respect to the other. Therefore, the system can adapt to different wheelbases of (distance between) the wheels of the rolling object. Furthermore, by moving the combined and simultaneous gripping and lifting means closer to or away from one another, ascent of the wheels of the rolling object in the system can be facilitated.

According to an implementation of the system according to the invention, the combined and simultaneous gripping and lifting means can comprise at least one set of two gripping (and lifting) elements whose principal axes are substantially perpendicular to the longitudinal direction of the chassis, the two gripping elements being suited to simultaneously grip and lift two wheels of the rolling object through a single control, such as a gripping element transverse motion (transverse translation) control. These two gripping elements allow, through a transverse motion for example, to grip and lift two wheels of the rolling object, one wheel in each gripping element.

According to an implementation of the invention, the combined and simultaneous gripping and lifting means can comprise at least one frame connected to the chassis and at least one tilt element (a tilterfor example) suited to support the wheel of the rolling object. A tilt element is capable of tilting about an axis. A tilt element can be a tilter. A tilter can notably comprise two plane parts rigidly connected to one another and forming a non-zero open angle, the axis of rotation of the tilter can be advantageously positioned at the connection between the two plane parts of the tilter so as to form a bend. Thus, the tilter can be a bent part. The two plane parts of the tilter can thus serve to tilt (or pivot) the tilter about its axis of rotation, in one direction or the other, without requiring an actuator to generate this tilt. In other words, the tilter is capable of generating tilt of the tilter only through the motion (translation) of the wheel of the rolling object towards the tilter, without an actuator. This allows to move at least one of the two parts of the tilter close to the floor or, on the contrary, to provide a sufficient ground clearance between the two parts of the tilter and the floor.

The frame can be connected to at least one tilt element by a first pivot connection of substantially horizontal axis. The combined wheel gripping and lifting motion can therefore be achieved through tilting of the tilt element. This combined motion can be actuated for example by a translational motion applied or imparted to at least the first pivot connection of horizontal axis, the translational motion being directed towards the wheel of the rolling object, for example, in a transverse direction. This translational motion can for example be applied by a hydraulic, pneumatic or electric cylinder, or it can be manually performed by the user.

The tilt element can tilt about its axis of rotation through the motion of the wheel of the rolling object towards the tilt element, without requiring an actuator to generate the tilt. The system thus is simple and reliable.

Advantageously, the tilt element at rest is at a non-zero minimum distance from the floor, so as to have a minimum ground clearance and thereby to prevent the tilt element from hindering movement of the trolley.

Preferably, the combined and simultaneous gripping and lifting means can comprise at least two tilt elements, the tilt elements being connected to each other, two by two, through substantially horizontal and parallel pins, these pins being also parallel to the first pivot connection connecting one of the tilt elements to the frame. Thus, this multiplicity of tilt elements allows to reduce the forces required to initiate the wheel gripping and lifting motion in the combined and simultaneous gripping and lifting means. Thus, the force required to grip and lift the wheels of the rolling object is reduced. The cost of the system can thus be reduced and the energy necessary for the system is reduced. The mass of the system can also be reduced.

Advantageously, when the combined and simultaneous gripping and lifting means comprises at least two tilt elements, stop pieces can be positioned on at least one of the tilt elements so as to allow the other tilt element to rest thereon, notably when the combined and simultaneous gripping and lifting means is in raised position.

Preferably, the combined and simultaneous gripping and lifting means can comprise at least one device for limiting the angular clearance of at least one tilt element. The angular clearance limiting device can notably limit the angular clearance of at least one tilt element. Therefore, the force required to initiate gripping and lifting of the wheels of the rolling object can be reduced. In a sense, the angular clearance limiting device acts in a manner similar to the addition of a tilt element in the system. The angular clearance limiting device thus facilitates gripping and initial lifting of the wheel of the rolling object.

Advantageously, the combined and simultaneous gripping and lifting means can comprise at least one holding piece for holding at least one tilt element in raised position. A raised position is defined as the final position of the combined and simultaneous gripping and lifting means when the wheel of the rolling object is gripped and lifted in the combined and simultaneous gripping and lifting means. The holding piece can be, for example, a stop, preferably made from a flexible material such as rubber, so as to prevent shocks with the tilt element. The holding piece allows the tilt element or the wheel to be supported when it is in raised position.

According to a configuration of the invention, the combined gripping and lifting means can comprise a guide element for orienting the wheel of the rolling object in a direction close to the direction substantially perpendicular to the longitudinal direction, i.e. substantially transverse, of the chassis of the propulsion system, prior to gripping and lifting the wheel of the rolling object. In other words, when the propulsion system is moved close to the rolling object, at least one of the wheels of the rolling object, preferably two, comes into contact with the guide element allowing to guide the wheel of the rolling object so as to pre-orient it in the direction of the combined and simultaneous gripping and lifting means, of the tilt element and/or of the frame for example. The guide element is therefore substantially orthogonal to the axis of rotation of the tilt element. By orienting the wheel of the rolling object in a substantially transverse direction, the motion (translation) in the longitudinal direction between the propulsion system and the rolling object is limited, which allows the rolling object to be immobilized at the propulsion system prior to and during the coupling phase. Furthermore, orienting the wheels of the rolling object in a substantially transverse direction allows these wheels to be pre-oriented towards the gripping elements, arranged in the transverse direction (for example with the axis of rotation of the tilt element in the longitudinal direction), and it thus facilitates gripping and lifting of the wheels of the rolling object. Advantageously, the position of the guide element can be adjusted, in the longitudinal direction for example, so as to adapt to different wheels of the rolling object, different wheel diameters, different types of single or dual wheels, etc.

According to an embodiment of the invention, at least one tilt element can comprise a guide piece for orienting the wheel of the rolling object in the tilt element comprising the guide piece. This guide piece can notably comprise a part forming a non-zero angle, preferably between 5° and 30°, with respect to the ends of the tilt element (ends perpendicular to the axis of rotation of these tilt elements). When the axis of the tilt element is substantially longitudinal, the guide piece comprises a part forming a non-zero angle with respect to the longitudinal ends of the tilt element extending in the transverse direction. In other words, the guide piece comprises a part extending, in the horizontal plane, in a direction forming a non-zero angle with the transverse direction. Thus, the wheel of the rolling object, positioned in the combined and simultaneous gripping and lifting means, comes into contact with the guide piece, possibly after being pre-oriented by the guide element, through at least this inclined part (in the horizontal plane with respect to the transverse direction). Contact between this inclined part and the wheel allows the wheel to be guided in the desired direction, the substantially transverse direction for example. The guide element pre-orients the wheel of the rolling object in the direction of the gripping elements, prior to contact of the wheel of the rolling object with these gripping elements, then the guide piece finalizes the orientation of the wheel of the rolling object in the gripping element (tilt element and/or frame for example) so as to facilitate gripping and lifting thereof.

According to a variant of the invention, at least one tilt element can comprise a means of adjusting the width of the tilt element. Thus, the width of the tilt element can be adapted to the width of the wheel of the rolling object. The tilt element with the width adjustment means enables adaptation for single wheels and dual wheels. Single wheels consist of only one wheel rotating about a horizontal axis of rotation. Dual wheels consist of two wheels rotating about a single horizontal axis of rotation. The means of adjusting the width of the tilt element allows to improve gripping and lifting of the wheels of the rolling object, as well as immobilization thereof, the means of adjusting the width of the tilt element allowing the clearance between the wheel of the rolling object and the tilt element to be limited.

The width of the tilt element is understood to be the distance between the ends of the tilt element, the ends extending along the axis of rotation of the tilt element. For example, when the axis of the tilt element is substantially longitudinal, the width of the tilt element is the distance, in the longitudinal direction, between the ends of the tilt element. The width of the tilt element thus adapts to the width of the wheel, which may be a single or a dual wheel.

Preferably, the means of adjusting the width of the tilt element can be a mobile flange. A mobile flange is a part, a plate or a piece of a plate for example, translatably mobile in the direction of the axis of the tilt element. Thus, the user can position the flange with the width suited to the wheel of the rolling object.

According to another variant, the means of adjusting the width of the tilt element can be a shim. Therefore, the shim can be set on or removed from the tilt element. A set of shims can be used so as to adapt to various wheel widths of the rolling object. The shim can be removable.

According to a preferred embodiment of the invention, the combined and simultaneous gripping and lifting means is configured to simultaneously achieve gripping and lifting of at least two wheels of the rolling object. Thus, a translational motion can allow the gripping elements (tilt elements and/or frame for example) to move towards the wheels of the rolling object. Moving the gripping means closer to the wheels of the rolling object simultaneously facilitates gripping and lifting of the two wheels of the rolling object.

Preferably, the at least two wheels of the rolling object can be positioned on an axis substantially transverse to the electric propulsion system. Thus, an actuator such as a cylinder, positioned in the transverse direction, can move the gripping elements (frame and/or tilt elements for example) towards the wheels of the rolling object, thereby facilitating gripping and lifting thereof. This can allow to use a single actuator for simultaneously gripping and lifting two wheels of the rolling object.

According to another variant of the invention, the electric propulsion system can comprise two combined and simultaneous gripping and lifting means, each combined and simultaneous gripping and lifting means comprising an actuator. The system then has two actuators, two cylinders for example. Each actuator is connected, on the one hand, to the chassis and, on the other hand, to a gripping element of the combined and simultaneous gripping and lifting means it belongs to. Using two cylinders, each cylinder being connected on the one hand to the chassis and on the other hand to a different combined and simultaneous gripping and lifting means, is particularly advantageous compared to a single cylinder allowing two combined and simultaneous gripping and lifting means to be moved away from one another. Indeed, using two cylinders allows to have a significant gap length while keeping reduced size and compactness, and a light system. In addition, this provides a higher separation speed of the combined and simultaneous gripping and lifting means.

Advantageously, the combined and simultaneous gripping and lifting means can comprise at least one means enabling motion in the transverse direction of the combined and simultaneous gripping and lifting means, the transverse direction being orthogonal to the longitudinal direction. A means providing motion in the transverse direction can notably be a linear actuator such as a cylinder and it allows the gripping element (frame and/or tilt elements for example) to be moved towards the wheel of the rolling object. Thus, the user does not need to push the propulsion system towards the rolling object. Gripping and lifting of the wheel of the rolling object is thus facilitated. In addition, when the combined and simultaneous gripping and lifting means is configured to simultaneously grip and lift two wheels of the rolling object, a single moving means allows to simultaneously grip and lift the two wheels of the rolling object, without any user effort. Indeed, moving the gripping elements towards one another for example allows to take and lift the wheels of the rolling object from the outside. On the other hand, moving the gripping elements in the opposite direction allows to take and lift the wheels of the rolling object from the inside.

Advantageously, the combined and simultaneous gripping and lifting means can comprise a first stop for immobilizing the rolling object. This first stop can notably comprise rubber or an equivalent material. This first stop can be positioned on the frame and come into contact with the wheel of the rolling object when gripping and lifting of the wheel of the rolling object is finalized, so as to prevent contact of the wheel of the rolling object with the frame.

According to an advantageous implementation, the combined and simultaneous gripping and lifting means can comprise a raising device configured to ensure a ground clearance greater than a predetermined height, 40 mm for example, in raised position for example. Indeed, when the gripping and lifting means is in rest position, the rest position being defined by the position of the combined and simultaneous gripping and lifting means free from any movement, therefore supporting no wheel, at least part of the gripping element (the tilt element for example) can be close to the floor to facilitate gripping and lifting of the wheel of the rolling object. This position is thus advantageous to facilitate coupling, but it is particularly inconvenient for handling the propulsion system without it being coupled to a rolling object, for example when a user utilizes the propulsion system in scooter mode, standing on a platform supported by the chassis, because the ground clearance is then very limited. Thus, in rest position, the propulsion system is likely to jam or to stop regularly as soon as a small obstacle appears. Furthermore, this low ground clearance is likely to cause damage to the combined and simultaneous gripping and lifting means. This is the reason why a raising device can be provided. The raising device allows to raise (elevate) the gripping elements (tilt elements for example), without a wheel of the rolling object being gripped and lifted, so as to increase the ground clearance. A minimum ground clearance of 40 mm for example allows to keep a compact and easy-to-use system, and to limit jam risks and damage to the system. This raising device is also advantageous for use of the propulsion system in scooter mode in order to prevent the user from falling.

Advantageously, the raising device can comprise at least one return spring and/or at least one counterweight and/or at least one driven rod.

A return spring can allow to return a tilt element for example to a raised position as soon as the system is not coupled to a rolling object. Return to the raised position is then automatic.

A counterweight positioned on a tilt element for example on the side opposite the one close to the ground in rest position (without the counterweight) can allow to naturally bring the rest position to a position close to the raised position.

A rod driven by a cylinder, a linear actuator driven by a motor or any other drive system can also allow the gripping elements to be moved upwards so as to increase the ground clearance.

Preferably, the combined and simultaneous gripping and lifting means can comprise an adjustment means in longitudinal position. In other words, the combined and simultaneous gripping and lifting means can be moved on the chassis along the longitudinal axis. This notably allows to get close to the wheel of the rolling object so as to facilitate coupling operations. The adjustment means in longitudinal position can notably comprise a linear actuator such as a hydraulic, pneumatic or electric cylinder acting as a longitudinal slideway.

According to an embodiment of the invention, the coupling means can comprise two combined and simultaneous gripping and lifting means, one being configured to grip and lift at least one wheel of the rolling object oriented in the transverse direction, the other being configured to grip and lift at least one wheel of the rolling object (preferably two wheels of the rolling object) oriented in a longitudinal direction. Thus, the electric propulsion system is suitable for lifting rolling objects having orientable wheels, such as a rolling bed, wheels that can be oriented in the transverse direction, and it is suitable for lifting rolling objects having non-orientable wheels such as the rear wheels of wheelchairs, which can then be gripped in the second combined and simultaneous gripping and lifting means, in the longitudinal direction. The system adaptability is thus improved.

The first combined and simultaneous gripping and lifting means (that grips and lifts the wheels of the rolling object in the transverse direction) can correspond to one of the various features described above in this description.

Preferably, the second combined and simultaneous gripping and lifting means (that grips and lifts the wheels of the rolling object in the longitudinal direction) can comprise a mount (a second frame), at least one arm extensible in a predetermined direction (longitudinal or transverse for example) connected to the mount, at least a third tilt element and at least one push device. The third tilt element and the push device can be connected, for one, to said extensible arm, and the other to the mount. For example, the third tilt element can be connected to the mount (by a pivot connection of transverse axis for example) and the push device can be connected (attached for example) to the extensible arm. Alternatively, the third tilt element can be connected to the extensible arm (by a pivot connection of transverse axis for example) and the push device can be connected (attached for example) to the mount.

The push device is suited to push at least one wheel of the rolling object in the longitudinal direction into the third tilt element. When the push device is positioned on the extensible arm, a longitudinal motion of the extensible arm pushes the wheel towards, then into the third tilt element. When the push device is positioned on the mount, the longitudinal motion of the extensible arm is transmitted to the third tilt element. In this case, the push device acts to prevent the wheel from continuing its longitudinal motion. Thus, the push device pushes (through a force applied by the wheel of the rolling object on the push device) the wheel into the third tilt element. The third tilt element and the push device are therefore opposite one another along a longitudinal direction.

In addition, the third tilt element is adapted to tilt about an axis of substantially transverse direction.

Thus, through a motion of the extensible arm in the predetermined direction (longitudinal or transverse for example) and oriented towards the mount, it is possible to push the wheel of the rolling object, by means of the push device, into the third tilt element. Furthermore, from the contact of the wheel with the third tilt element, the continuation of the action performed by the extensible arm allows to grip and to lift the wheel of the rolling object in the third tilt element. The third tilt element can be designed to automatically tilt under the effect of the forces of the wheel of the rolling object and of its motion in the predetermined direction. Therefore, the third tilt element has no tilt control means.

According to this configuration, the third tilt element can be connected to the mount or to the extensible arm by a pivot connection in a substantially transverse direction. The third tilt element can thus tilt about this transverse axis when the wheel of the rolling object moves in the longitudinal direction.

The third tilt element can notably be a tilter. A tilter according to the invention comprises a bent piece in two parts, this bent piece being in pivot connection about an axis, preferably of transverse direction, about which it can tilt. The two parts of the bent piece join substantially at the transverse axis serving as the pivot. In other words, the bend of the tilter is located at the transverse axis. The wheel of the rolling object first comes into contact with one of the two parts at a first contact point, then it tilts about the first contact point and comes into contact with a second contact point on the other part of the tilter. The longitudinal movement of the wheel, pushed by the push device, shifts the centre of gravity of the assembly with respect to the transverse pivot axis and causes the assembly to tilt about this pivot axis.

The mount can be connected to the chassis by either a fixing device or a sliding connection. Fastening to the chassis can notably be used when a single wheel of the rolling object (a tricycle for example) is to be gripped. The sliding connection provides an improved degree of adaptation of the system allowing two wheels of the rolling object to be gripped.

For example, a motorized wheel can be arranged at one longitudinal end of the chassis and two non-motorized wheels can be arranged at the other longitudinal end of the propulsion system, on the extensible arm, the vertical axis of the motorized wheel being preferably, in top view, on the mid-perpendicular of the vertical axes of the non-motorized wheels in top view. Therefore, the mid-perpendicular of the vertical axes extends in the longitudinal direction of the chassis (and of the propulsion system).

The invention also relates to a coupled assembly made up of a rolling object and of an electric propulsion system as described above, said rolling object being coupled to the electric propulsion system by the coupling means. Such a coupled assembly facilitates the maneuvers of the rolling object, notably in a reduced space, as well as the coupling and uncoupling operations.

The invention further relates to a method for coupling a rolling object to the electric propulsion system described above. This method notably comprises the following steps:

a) moving longitudinally the electric propulsion system and/or the combined and simultaneous gripping and lifting means (for example with the longitudinal position adjustment means) so as to bring the gripping and lifting means close to at least one wheel of the rolling object,
b) moving the combined and simultaneous gripping and lifting means or the electric propulsion means in the transverse direction to enable contact between the wheel of the rolling object and the combined and simultaneous gripping and lifting means; when the system is configured to simultaneously grip and lift two wheels of the rolling object, the gripping elements can be moved towards the wheels of the rolling object, the gripping elements moving in opposite directions relative to one another, this motion causing gripping and lifting of the two wheels, without the user having to block the movement of the bed or of the propulsion system,
c) continuing the motion in the transverse direction so as to enable combined and simultaneous gripping and lifting of at least one wheel of the rolling object, the applied motion causing gripping and lifting of the wheel of the rolling object in the combined and simultaneous gripping and lifting means.

Preferably, before the wheel contacts the tilt element, the wheel of the rolling object can be pre-oriented by the guide element of the combined and simultaneous gripping and lifting means.

Advantageously, after this pre-orientation, when the wheel of the rolling object is in contact with the tilt element, orientation of the wheel of the rolling object in the tilt element by the guide piece can be finalized.

According to an advantageous implementation, two wheels of the rolling object can be simultaneously gripped and lifted so as to facilitate coupling of the rolling object to the propulsion system, through the motion (translation) in opposite directions of the two gripping elements, and these motions can be generated by a single actuator common to the two gripping elements.

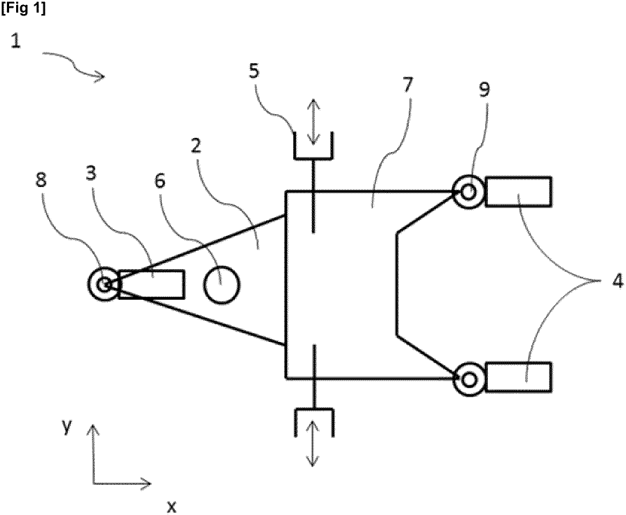

FIG. 1 schematically illustrates, by way of non-limitative example, an electric propulsion system 1 according to an embodiment of the invention. FIG. 1 is a top view of electric propulsion system 1. Electric propulsion system 1 comprises a chassis 2. Axis x corresponds to the longitudinal axis of chassis 2 and to the principal direction of travel of propulsion system 1, and axis y corresponds to the lateral axis of chassis 2 (axis z, which is not shown, is vertical). Chassis 2 supports three wheels (alternatively, chassis 2 can comprise fourwheels). Chassis 2 supports, at one of the longitudinal ends thereof, a wheel 3 (alternatively, chassis 2 may support two wheels 3), which is a wheel driven by an electric machine (not shown). Wheel 3 is orientable with respect to chassis 2, about a vertical axis 8. At the other longitudinal end of the chassis, chassis 2 supports two wheels 4, which are wheels that are not driven by an electric machine. These two wheels 4 are off-centered wheels orientable about vertical axes 9. Electric propulsion system 1 further comprises coupling means 5.

According to the embodiment illustrated, electric propulsion system 1 comprises two coupling means 5 on either side of the chassis in the lateral direction (axis y) so as to achieve coupling by means of two wheels of the rolling object (not shown). Coupling means 5 comprise combined and simultaneous gripping and lifting means, shown in simplified manner as clamps. The lateral translational motion of coupling means 5 is shown by a double arrow. This lateral motion can serve for gripping and orienting the wheels of the rolling object. Coupling means 5 are arranged, in direction x, between motorized wheel 3 and orientable off-centered wheels 4.

Furthermore, electric propulsion system 1 comprises a handlebar 6, for example in form of a rod equipped with a handle (not shown).

Besides, electric propulsion system 1 comprises a supporting platform 7 (for supporting a user for example). Platform 7 is arranged at the end of frame 2 supporting non-motorized wheels 4.

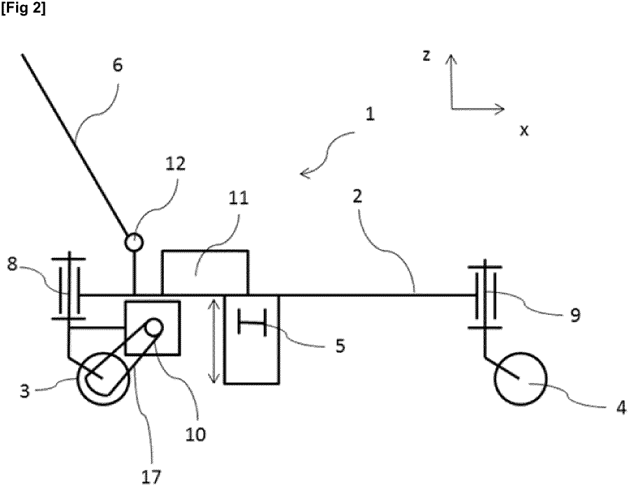

FIG. 2 schematically illustrates, by way of non-limitative example, an electric propulsion system 1 according to a first variant embodiment of the invention. FIG. 2 is a side view of electric propulsion system 1. Electric propulsion system 1 comprises a chassis 2. Axis x corresponds to the longitudinal axis of chassis 2 and to the principal direction of travel of the propulsion system, and axis z corresponds to the vertical axis of chassis 2, axis y (not shown) corresponding to the transverse axis. Chassis 2 supports three wheels. Chassis 2 supports a wheel 3, which is driven by an electric machine 10 by means of a drive 17, a belt or a chain for example (alternatively, electric machine 10 can be directly connected to wheel 3). Wheel 3 is orientable relative to chassis 2, around a vertical axis 8. Electric machine 10 can be secured to pivot 8 of motorized wheel 3. At the other end, chassis 2 supports two wheels 4, which are two wheels that are not driven by an electric machine. Wheels 4 are off-centered and orientable relative to chassis 2 around vertical axes 9. Electric propulsion system 1 further comprises coupling means 5. According to the embodiment illustrated, electric propulsion system 1 comprises two coupling means 5, on either side of chassis 2 in the lateral direction (axis y) so as to provide coupling by means of two wheels of the rolling object (not shown). Coupling means 5 are shown in a simplified manner as clamps. The vertical motion of coupling means 5 is shown by a double arrow. This vertical motion of the coupling means allows combined and simultaneous gripping and lifting of the wheels of the rolling object, this vertical motion being simultaneous and combined with the transverse motion of coupling means 5 so as to simultaneously generate gripping and lifting of the wheels of the rolling object. Coupling means 5 are arranged, in direction x, between motorized wheel 3 and orientable off-centered wheels 4.

Furthermore, electric propulsion system 1 comprises a handlebar 6, for example in form of a rod equipped with a handle (not shown) connected to chassis 2 by a joint 12.

Besides, electric propulsion system 1 comprises a battery 11. Battery 11 is arranged on chassis 2 close to electric machine 10 and motorized wheel 3.

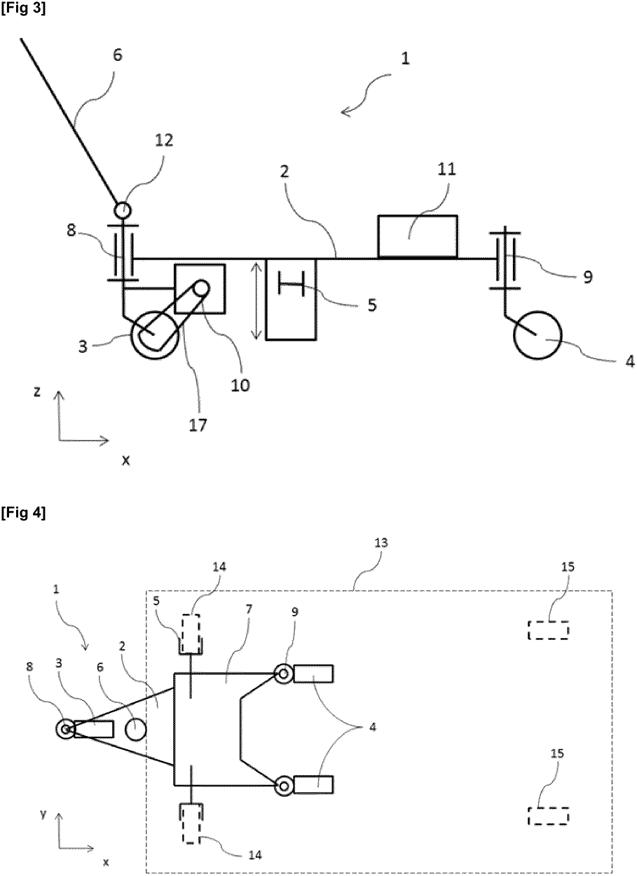

FIG. 3 schematically illustrates, by way of non-limitative example, an electric propulsion system 1 according to a second variant embodiment of the invention. FIG. 3 is a side view of electric propulsion system 1. Electric propulsion system 1 comprises a chassis 2. Axis x corresponds to the longitudinal axis of chassis 2 and to the principal direction of travel of the propulsion system, and axis z corresponds to the vertical axis of chassis 2. Chassis 2 supports three wheels. Chassis 2 supports a wheel 3, which is driven by an electric machine 10 by means of a drive 17, a belt or a chain for example. Wheel 3 is orientable relative to chassis 2, around a vertical axis 8. Electric machine 10 can be secured to pivot 8 of motorized wheel 3. At the other end, chassis 2 supports two wheels 4, which are two wheels that are not driven by an electric machine. Wheels 4 are off-centered and orientable relative to the chassis around vertical axes 9.

Electric propulsion system 1 further comprises coupling means 5. According to the embodiment illustrated, electric propulsion system 1 comprises two coupling means 5, on either side of the chassis in the lateral direction (axis y) so as to provide coupling by means of two wheels of the rolling object (not shown). Coupling means 5 are shown in a simplified manner as clamps. The vertical (translational) motion of coupling means 5 is shown by a double arrow. This vertical motion of the coupling means allows combined and simultaneous gripping and lifting of the wheels of the rolling object. This vertical motion is driven by the transverse motion (transverse translation) of the combined and simultaneous gripping and lifting means, driven by an actuator. Coupling means 5 are arranged, in direction x, between motorized wheel 3 and orientable off-centered wheels 4.

Furthermore, electric propulsion system 1 comprises a handlebar 6, for example in form of a rod equipped with a handle (not shown) connected to vertical-orientation pin 8 of motorized wheel 3 by a joint 12.

Besides, electric propulsion system 1 comprises a battery 11. Battery 11 is arranged on chassis 2 close to non-motorized wheels 4.

FIG. 4 schematically illustrates, by way of non-limitative example, an electric propulsion system 1 according to an embodiment of the invention, coupled to a rolling object 13. FIG. 4 is a top view of electric propulsion system 1 and of rolling object 13. The embodiment of FIG. 4 corresponds to the embodiment of FIG. 1. Rolling object 13 can be of any type, notably a rolling bed. The rolling object comprises two wheels 14, arbitrarily referred to as rear wheels, and two wheels 15, arbitrarily referred to as front wheels. Electric propulsion system 1 comprises a chassis 2. Axis x corresponds to the longitudinal axis of chassis 2 and to the principal direction of travel of propulsion system 1, and axis y corresponds to the lateral axis of chassis 2. The chassis supports three wheels. Chassis 2 supports a wheel 3, which is a wheel driven by an electric machine (not shown). Wheel 3 is orientable with respect to chassis 2, around a vertical axis 8. At the other end, chassis 2 supports two wheels 4, which are two wheels that are not driven by an electric machine. Wheels 4 are off-centered and orientable with respect to chassis 2 around vertical axes 9. Electric propulsion system 1 further comprises coupling means 5. According to the embodiment illustrated, electric propulsion system 1 comprises two coupling means 5 on either side of chassis 2 in the lateral direction (axis y) in order to achieve coupling by means of two rear wheels 14 of rolling object 13. Coupling means 5 comprise combined and simultaneous gripping and lifting means, shown in a simplified manner as clamps. Rear wheels 14 of rolling object 13 are arranged in the combined and simultaneous gripping and lifting means, and they are oriented along axis y, i.e. an axis perpendicular to the longitudinal axis (axis x) of chassis 2. Furthermore, front wheels 15 of the rolling object are free and not coupled.

Electric propulsion system 1 also comprises a handlebar 6, for example in form of a rod equipped with a handle (not shown) articulated relative to chassis 2.

Besides, electric propulsion system 1 comprises a supporting platform 7 (for supporting a user for example). Platform 7 is arranged at the end of chassis 2 supporting non-motorized wheels 4. For the embodiment of FIG. 4, coupling means 5, non-motorized wheels 4, platform 7 and a major part of chassis 2 are located beneath the rolling object. Only motorized wheel 3 and handlebar 6 can protrude from rolling object 13 in the longitudinal direction x of chassis 2.

FIG. 8 schematically illustrates (in top view), by way of non-limitative example, an embodiment of coupling a rolling object (represented by these rear wheels 14) to propulsion system 1. The references corresponding to those already used correspond to the same elements and will therefore not be detailed again here. The combined and simultaneous gripping and lifting means comprise immobilization arms 19 arranged on the outside of chassis 2 relative to gripping elements 18. By comparison, in FIGS. 1 and 4 for example, the immobilization elements are represented by the U on the inner side of the chassis. Thus, in the example of FIGS. 1 and 4, to simultaneously grip and lift the two wheels 14 of the rolling object, the combined and simultaneous gripping and lifting means move in opposite directions to one another: the combined and simultaneous gripping and lifting means at the top of the figure moves in direction y to grip and lift wheel 14 of the rolling object while the combined and simultaneous gripping and lifting means at the bottom of the figure moves in the opposite direction to y to grip and lift wheel 14 of the rolling object. On the other hand, in FIG. 8, in order to grip and lift wheels 14 of the rolling object, the combined and simultaneous gripping and lifting means move towards one another.

In the example of FIG. 8, the docking arms of the combined and simultaneous gripping and lifting means 20 are moved closer to one another (i.e. moved towards the inside of chassis 2, by means of cylinders for example) until immobilization arms 19 come into contact with and abut against gripped wheels 14. In this example, the motion of non-motorized wheels 4 of the structure is preferably left free.

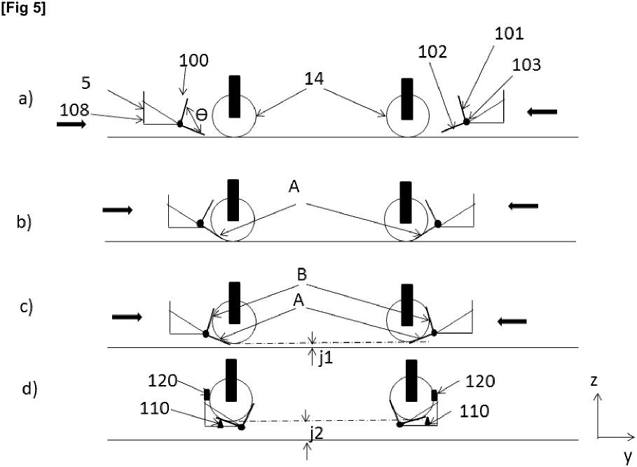

FIG. 5 schematically illustrates, by way of non-limitative example, a first embodiment of the combined and simultaneous gripping and lifting means of a propulsion system according to the invention.

This propulsion system comprises means 5 for coupling to combined and simultaneous gripping and lifting means. These combined and simultaneous gripping and lifting means comprise gripping elements including a frame 108, which is a structure that cannot move vertically. A tilt element (a tilter for example) 100 is fastened to this frame 108. This tilt element 100 is connected to frame 108 by a pivot connection 103 of horizontal axis, in the longitudinal direction here, orthogonal to the cutting plane, direction y representing the transverse direction and direction z representing the vertical direction. Tilt element 100 comprises two plane parts 101 and 102 rigidly fixed to each other and forming a non-zero angle θ, thus forming a bent piece. Pivot connection 103 is advantageously positioned at the link between the two parts 101 and 102 forming open angle θ.

Using plane parts 101 and 102 allows to simplify the manufacture and to facilitate lifting of the wheel of the rolling object.

FIG. 5 illustrates with four diagrams a), b), c) and d) the different steps relative to the approach, gripping and lifting of two wheels of the rolling object.

In step a), the two wheels 14 of the rolling object are not in contact with the combined and simultaneous gripping and lifting means. They are notably at a distance from parts 102 of tilt element 100, these parts 102 being at a short distance from the ground to facilitate gripping and lifting of the wheels.

The black arrows represent the movement (translation) applied to the combined and simultaneous gripping and lifting means, towards one another, in the direction of wheels 14 of the rolling object.

In step b), the combined and simultaneous gripping and lifting means come into contact with wheels 14 of the rolling object at contact point A. Wheel support parts 102 come into contact with wheels 14 of the rolling object.

As the transverse motion (translation) of the combined and simultaneous gripping and lifting means towards one another continues, the distance between the two wheels 14 of the rolling object being fixed, parts 102 of tilt elements 100 simultaneously allow to grip the wheels by involving a rotation of tilt element 100 until the wheel is in contact with the tilt element at A and B, and to start their lift above the ground, as shown in diagram c). Indeed, a clearance j1 appears between the lower part of wheels 14 of the rolling object and the ground, represented in the various diagrams by a solid horizontal line. It is also noted that tilt element 100 has slightly rotated around its pivot connection 103, the wheel being in contact with wheel support part 102 at contact point A and with the other part 101 of tilt element 100 at contact point B.

As the transverse motion (translation) of the combined and simultaneous gripping and lifting means towards one another continues, the distance between wheels 14 of the rolling object being fixed, each tilt element 100 is driven in rotation around its pivot connection 103 by bearing of each wheel 14 of the rolling object in tilt element 100. The combined and simultaneous gripping and lifting means continue to grip and lift wheels 14 of the rolling object until reaching the final position shown in diagram d), where clearance j2 between the lower part of each wheel 14 of the rolling object and the ground is maximal. In this final position, each wheel 14 of the rolling object is immobilized in coupling means 5 and rests, in the transverse direction, against first stops 120 positioned on frame 108. Furthermore, a holding part 110 allows tilt element 100 to be held in this position, referred to as raised position, against frame 108. This holding part 110, also positioned on frame 108, is arranged under tilt element 100 in raised position. Holding part 110 allows to take up the forces related to the weight of the rolling object on the combined and simultaneous gripping and lifting means, thereby allowing to limit the fatigue of tilt elements 100.

Holding part 110 and/or first stops 120 are preferably made of a flexible material such as rubber so as to avoid hyperstatism on the one hand and to adapt to different wheel diameters on the other hand.

Thus, by imposing a single horizontal translational movement (black arrow), gripping and lifting of the wheels of the rolling object is carried out in a combined and simultaneous manner.

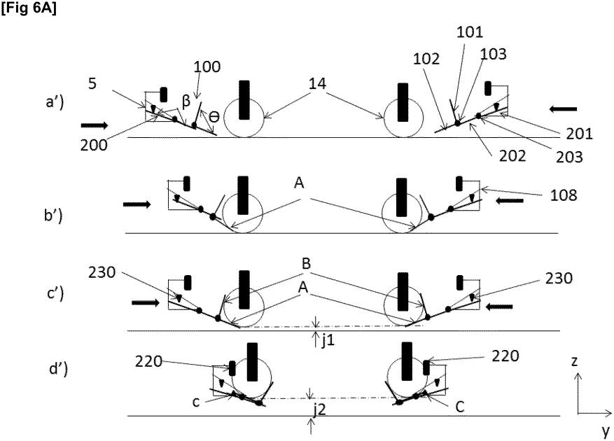

FIGS. 6A and 6B schematically illustrate, by way of non-limitative example, two embodiments of a combined and simultaneous gripping and lifting means of a propulsion system according to the invention.

In these figures, the propulsion system comprises means 5 for coupling to combined and simultaneous gripping and lifting means. These combined and simultaneous gripping and lifting means comprise gripping elements including a frame 108, which is a structure that cannot move vertically. A second tilt element (a tilter for example) 200 is connected to this frame 108. This second tilt element 200 is connected to frame 108 by a pivot connection 203 of horizontal axis, in the longitudinal direction here, orthogonal to the cutting plane, direction y representing the transverse direction and direction z representing the vertical direction. Tilt element 200, a tilter for example, comprises two parts 201 and 202 rigidly fixed to each other and forming a non-zero open angle β, thus forming a bent piece. Pivot connection 203 is advantageously positioned at the link between the two plane parts 201 and 202.

This second tilt element 200 is itself connected to a first tilt element 100 by a substantially horizontal pin 103 forming a pivot connection between the first and the second tilt element 100 and 200. Substantially horizontal pin 103 is oriented along the longitudinal direction (orthogonal to the plane of the diagrams of FIG. 6). This horizontal pin 103 is thus parallel to pivot connection 203. Horizontal pin 103 is advantageously positioned at the link between the two rigidly connected parts 101 and 102 forming a non-zero open angle θ, thus forming a bent part. Therefore, tilt element 100 can notably be a tilter. The multiplicity of tilt elements allows to reduce the force required to initiate gripping and lifting of wheels 14 of the rolling object.

FIGS. 6A and 6B illustrate with four diagrams a′), b′), c′) and d′) the different steps relative to the approach, gripping and lifting of two wheels of the rolling object.

In step a′), the two wheels 14 of the rolling object are not in contact with the combined and simultaneous gripping and lifting means. They are notably at a distance from parts 102 of first tilt element 100, these parts 102 being at a short distance from the ground to facilitate gripping and lifting of the wheels.

The black arrows represent the movement (translation) applied to the combined and simultaneous gripping and lifting means towards one another, in the direction of wheels 14 of the rolling object.

In step b′), the combined and simultaneous gripping and lifting means come into contact with wheels 14 of the rolling object at contact point A. Wheel support parts 102 of first tilt element 100 come into contact with wheels 14 of the rolling object.

As the transverse motion (translation) of the combined and simultaneous gripping and lifting means towards one another continues, the distance between the two wheels 14 of the rolling object being fixed, parts 102 of first tilt elements 100 simultaneously allow to grip the wheels by involving a rotation of tilt element 100 until the wheel is in contact with the tilt element at A and B, and to start their lift above the ground, as shown in diagram c′). Indeed, a clearance j1 appears between the lower part of wheels 14 of the rolling object and the ground, represented in the various diagrams by a solid horizontal line. It is also noted that each first tilt element 100 has slightly rotated around its pivot connection 103, the wheel being in contact with wheel support part 102 at contact point A and with the other part 101 of each first tilt element 100 at contact point B.

In FIG. 6A, as the transverse motion (translation) of the combined and simultaneous gripping and lifting means towards one another continues, the distance between wheels 14 of the rolling object being fixed, each first tilt element 100 is driven in rotation around its pivot connection 103 by bearing of each wheel 14 of the rolling object in each first tilt element 100, each first tilt element 100 coming into contact with a stop C positioned on tilt element 200, thus driving second tilt element 200 in rotation around its pivot connection 203.

In FIG. 6B, as the transverse motion (translation) of the combined and simultaneous gripping and lifting means towards one another continues, the distance between wheels 14 of the rolling object being fixed, each first tilt element 100 is driven in rotation around its pivot connection 103 by bearing of each wheel 14 of the rolling object in each first tilt element 100, wheel 14 of the rolling object coming into contact with a stop D positioned on tilt element 200, thus driving second tilt element 200 in rotation around its pivot connection 203. This configuration where wheel 14 of the rolling object comes into contact against a stop D of tilt element 200 allows the distribution of the forces to be improved, compared to the solution of FIG. 6A where tilt element 100 comes into contact with stop C of tilt element 200. Indeed, in this configuration where wheel 14 comes into contact with stop D, wheel 14 is then in contact with points A, B and with stop D, instead of being only in contact with points A and B.

Then, in FIG. 6A as well as in FIG. 6B, the combined and simultaneous gripping and lifting means continue to grip and lift wheels 14 of the rolling object until reaching the final position shown in diagram d′), where clearance j2 between the lower part of each wheel 14 of the rolling object and the ground is maximal. In this final position, each wheel 14 of the rolling object is immobilized in coupling means 5 and rests, in the transverse direction, against first stops 220 fastened on frame 108. Furthermore, an angular clearance limiting device 230 positioned on frame 108 prevents angular displacement of part 201 of second tilt element 200 beyond this angular clearance limiting device 230. In diagrams a′), b′) and c′), part 201 of second tilt element 200 is in contact with angular clearance limiting device 230 that thus fulfils its purpose by limiting the rotation of second tilt element 200 about its pivot connection 203. In diagram d′), part 201 of second tilt element 200 is no longer in contact with angular clearance limiting device 230.

Thus, by imposing a single horizontal translational movement (black arrow), gripping and lifting of the wheels of the rolling object is carried out in a combined and simultaneous manner.

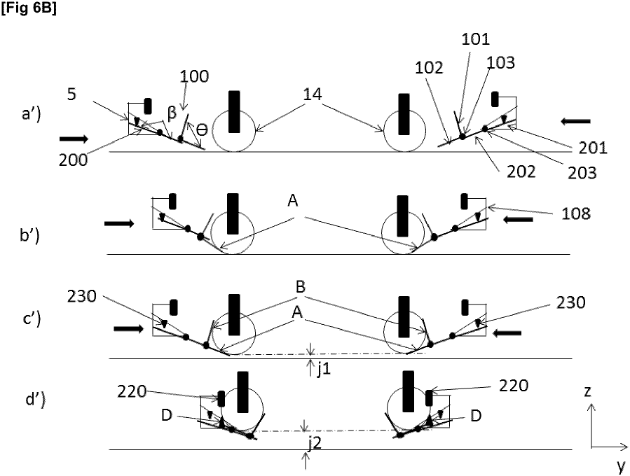

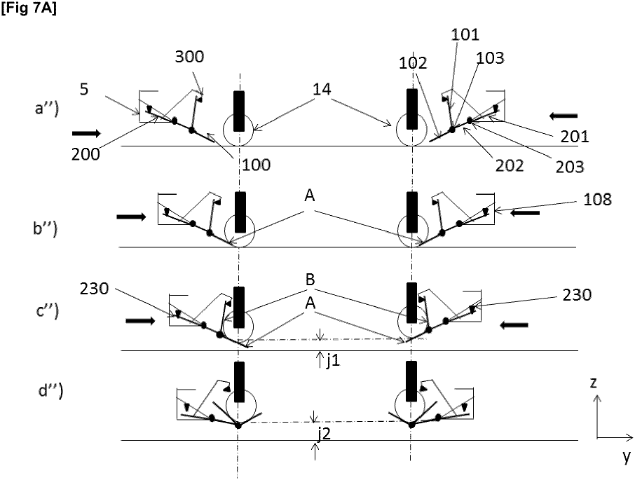

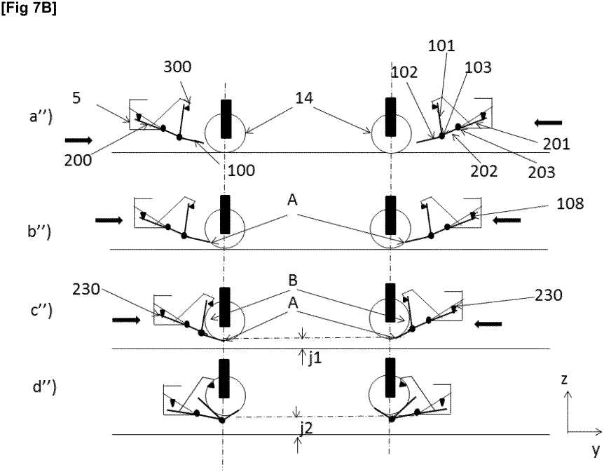

FIG. 7A schematically illustrates, by way of non-limitative example, another embodiment of a combined and simultaneous gripping and lifting means of a propulsion system according to the invention.

This propulsion system comprises means 5 for coupling to combined and simultaneous gripping and lifting means. These combined and simultaneous gripping and lifting means comprise gripping elements including a frame 108, which is a structure that cannot move vertically. A second tilt element (a tilter for example) 200 is fastened on this frame 108. This second tilt element 200 is connected to frame 108 by a pivot connection 203 of horizontal axis, in the longitudinal direction here, orthogonal to the cutting plane, direction y representing the transverse direction and direction z representing the vertical direction. Tilt element 200 comprises two parts 201 and 202 rigidly fixed to each other and forming a non-zero open angle. Pivot connection 203 is advantageously positioned at the link between the two parts 201 and 202.

This second tilt element 200 is itself connected to a first tilt element 100 by a substantially horizontal pin 103 forming a pivot connection between the first and the second tilt element 100 and 200. Substantially horizontal pin 103 is oriented along the longitudinal direction (orthogonal to the plane of the diagrams of FIG. 7A). This horizontal pin is thus parallel to pivot connection 203. Horizontal pin 103 is advantageously positioned at the link between the two rigidly connected plane parts 101 and 102 forming a non-zero open angle, the two parts 101 and 102 forming tilt element 100, a tilter for example. The multiplicity of tilt elements allows to reduce the force required to initiate gripping and lifting of wheels 14 of the rolling object.

The system also comprises an angular clearance limiting device 300 positioned on second tilt element 200, here on part 201 (alternatively on part 202), so as to limit the angular clearance of first tilt element 100 around its pivot pin 103.

FIG. 7A illustrates with four diagrams a″), b″), c″) and d″) the different steps relative to the approach, gripping and lifting of two wheels of the rolling object.

In step a″), the two wheels 14 of the rolling object are not in contact with the combined and simultaneous gripping and lifting means. They are notably at a distance from parts 102 of first tilt element 100, these parts 102 being at a short distance from the ground to facilitate gripping and lifting of the wheels.

The black arrows represent the displacement (translation) applied to the combined and simultaneous gripping and lifting means towards one another, in the direction of wheels 14 of the rolling object.

In step b″), the combined and simultaneous gripping and lifting means come into contact with wheels 14 of the rolling object at contact point A tangential to wheel 14 of the rolling object. Wheel support parts 102 of first tilt element 100 come into contact with wheels 14 of the rolling object.

As the transverse motion (translation) of the combined and simultaneous gripping and lifting means towards one another continues, the distance between the two wheels 14 of the rolling object being fixed, parts 102 of first tilt elements 100 simultaneously allow to grip the wheels and to start their lift above the ground, as shown in diagram c″). Indeed, wheels 14 roll along part 102 of the tilt element until the wheel is in contact with point B of element 101 and a clearance j1 appears between the lower part of wheels 14 of the rolling object and the ground, represented in the various diagrams by a solid horizontal line. It is also noted that, unlike diagram c′) of FIGS. 6A and 6B, each first tilt element 100 has not yet rotated around its pivot connection 103, whereas lifting of wheels 14 of the rolling object has started. This absence of rotation upon lifting is related to the presence of angular clearance limiting device 300. Then, wheel 14 of the rolling object comes into contact with wheel support part 102 at contact point A and with the other part 101 of each first tilt element 100 at contact point B.

As the transverse motion (translation) of the combined and simultaneous gripping and lifting means towards one another continues, the distance between wheels 14 of the rolling object being fixed, each first tilt element 100 is driven in rotation around its pivot connection 103 by bearing of each wheel 14 of the rolling object in each first tilt element 100, each first tilt element 100 driving second tilt element 200 in rotation around its pivot connection 203. Stops (not shown) can be provided between the wheel and tilt element 200, or between tilt element 100 and tilt element 200, to enable tilt element 200 to be driven in rotation. The combined and simultaneous gripping and lifting means continue to grip and lift wheels 14 of the rolling object until reaching the final position shown in diagram d″), where clearance j2 between the lower part of each wheel 14 of the rolling object and the ground is maximal. In this final position, each wheel 14 of the rolling object is immobilized in coupling means 5 and rests, in the transverse direction, against first stops (not shown) positioned on frame 108. Furthermore, a second angular clearance limiting device 230 positioned on frame 108 prevents angular displacement of part 201 of second tilt element 200 beyond this angular clearance limiting device 230. In diagrams a″), b″) and c″), part 201 of second tilt element 200 is in contact with angular clearance limiting device 230, which thus fulfils its purpose by limiting the rotation of second tilt element 200 around its pivot connection 203. In diagram d″), part 201 of second tilt element 200 is no longer in contact with angular clearance limiting device 230.

Such a configuration allows to maintain a substantially constant force for gripping and lifting the wheel of the rolling object immediately after contacting point A and until the wheel comes into contact with point B.

Thus, by imposing a single horizontal translational movement (black arrow), gripping and lifting of the wheels of the rolling object is carried out in a combined and simultaneous manner.

FIG. 7B schematically illustrates, by way of non-limitative example, another variant embodiment of a combined and simultaneous gripping and lifting means of a propulsion system according to the invention.

This propulsion system comprises means 5 for coupling to a combined and simultaneous gripping and lifting means. These combined and simultaneous gripping and lifting means comprise gripping elements including a frame 108, which is a structure that cannot move vertically. A second tilt element 200 (a tilter for example) is fastened to this frame 108. This second tilt element 200 is connected to frame 108 by a pivot connection 203 of horizontal axis, in the longitudinal direction here, orthogonal to the cutting plane, direction y representing the transverse direction and direction z representing the vertical direction. Tilt element 200 comprises two parts 201 and 202 rigidly fixed to each other and forming a non-zero open angle. Pivot connection 203 is advantageously positioned at the link between the two parts 201 and 202.

This second tilt element 200 is itself connected to a first tilt element 100 by a substantially horizontal pin 103 forming a pivot connection between the first and the second tilt element 100 and 200. Substantially horizontal pin 103 is oriented in the longitudinal direction (orthogonal to the plane of the diagrams of FIG. 7B). This horizontal pin is thus parallel to pivot connection 203. Horizontal pin 103 is advantageously positioned at the link between the two rigidly connected plane parts 101 and 102 forming a non-zero open angle, the two parts 101 and 102 making up tilt element 100, a tilter for example. The multiplicity of tilt elements allows to reduce the force required to initiate gripping and lifting of wheels 14 of the rolling object.

The system also comprises an angular clearance limiting device 300 positioned on second tilt element 200, on part 201 here (alternatively on part 202), so as to limit the angular clearance of first tilt element 100 around its pivot pin 103.

FIG. 7B illustrates with four diagrams a″), b″), c″) and d″) the different steps relative to the approach, gripping and lifting of two wheels of the rolling object.

In step a″), the two wheels 14 of the rolling object are not in contact with the combined and simultaneous gripping and lifting means. They are notably at a distance from parts 102 of first tilt element 100, these parts 102 being at a short distance from the ground to facilitate gripping and lifting of the wheels.

The black arrows represent the displacement (translation) applied to the combined and simultaneous gripping and lifting means towards one another, in the direction of wheels 14 of the rolling object.

In step b″), the combined and simultaneous gripping and lifting means come into contact with wheels 14 of the rolling object at contact point A, which is not tangential to wheel 14 of the rolling object, unlike FIG. 7A. Wheel support parts 102 of first tilt element 100 come into contact with wheels 14 of the rolling object.

As the transverse motion (translation) of the combined and simultaneous gripping and lifting means towards one another continues, the distance between the two wheels 14 of the rolling object being fixed, parts 102 of first tilt elements 100 simultaneously allow to grip the wheels and to start their lift above the ground, as shown in diagram c″). Indeed, wheels 14 of the rolling object tilt around the generatrix passing through point A and orthogonal to the cutting plane, and point A is not tangential to the wheel. Tilting of wheels 14 continues until the wheel is in contact with point B of element 101. In other words, the generatrix passing through point A and orthogonal to the cutting plane serves here as the rotation axis of wheel 14 of the rolling object. A clearance j1 appears between the lower part of wheels 14 of the rolling object and the ground, represented in the various diagrams by a solid horizontal line. It is also noted that, unlike diagram c′) of FIGS. 6A and 6B, each first tilt element 100 has not yet rotated around its pivot connection 103, whereas lifting of wheels 14 of the rolling object has started. This absence of rotation upon lifting is related to the presence of angular clearance limiting device 300.

As the transverse motion (translation) of the combined and simultaneous gripping and lifting means towards one another continues, the distance between wheels 14 of the rolling object being fixed, each first tilt element 100 is driven in rotation around its pivot connection 103 by bearing of each wheel 14 of the rolling object in each first tilt element 100, each first tilt element 100 driving second tilt element 200 in rotation around its pivot connection 203. Stops (not shown) can be provided between wheel 14 and tilt element 100, or between tilt element 200 and tilt element 100. The combined and simultaneous gripping and lifting means continue to grip and lift wheels 14 of the rolling object until reaching the final position shown in diagram d″), where clearance j2 between the lower part of each wheel 14 of the rolling object and the ground is maximal. In this final position, each wheel 14 of the rolling object is immobilized in coupling means 5 and rests, in the transverse direction, against first stops (not shown) positioned on frame 108. Furthermore, a second angular clearance limiting device 230 positioned on frame 108 prevents angular displacement of part 201 of second tilt element 200 beyond this angular clearance limiting device 230. In diagrams a″), b″) and c″), part 201 of second tilt element 200 is in contact with angular clearance limiting device 230, which thus fulfils its purpose by limiting the rotation of second tilt element 200 around its pivot connection 203. In diagram d″), part 201 of second tilt element 200 is no longer in contact with angular clearance limiting device 230.

The tilt effect of the wheel after contacting at point A allows in this case to decrease the force required for gripping and lifting the wheel until the wheel comes into contact with point B.

Thus, by imposing a single horizontal translational movement (black arrow), gripping and lifting of the wheels of the rolling object is carried out in a combined and simultaneous manner.

FIG. 16 schematically illustrates, by way of non-limitative example, a variant of FIGS. 7A and 7B. Indeed, in this figure, tilt element 100 comprises a support part 102 and a second part 101.

Support part 102 comprises a part 102a and a part 102b. When wheel 14 comes into contact with the rolling object as shown in the left-hand diagram, wheel 14 comes into contact with part 102a at contact point A, wheel 14 of the rolling object being then tangential to part 102a. The wheel can then rotate on part 102a up to point A′ that defines the connection between part 102a and part 102b. At point A′, wheel 14 of the rolling object then tilts around point A′ until it comes into contact with point B of part 101.

This configuration allows to have a constant force when the wheel rolls over part 102a, then to decrease the force required for gripping the wheel when the wheel tilts around point A′ until wheel 14 comes into contact with point B.

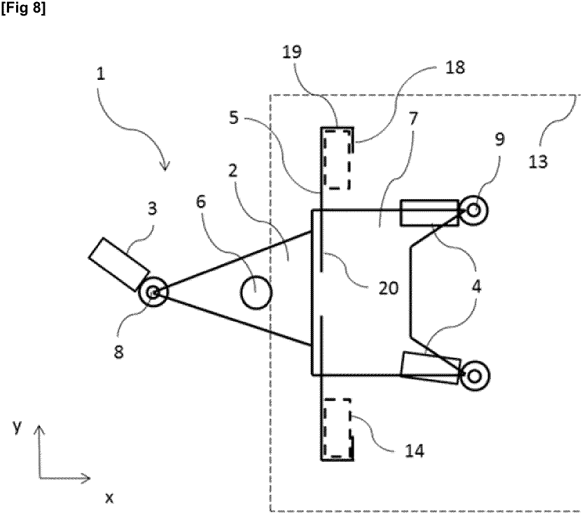

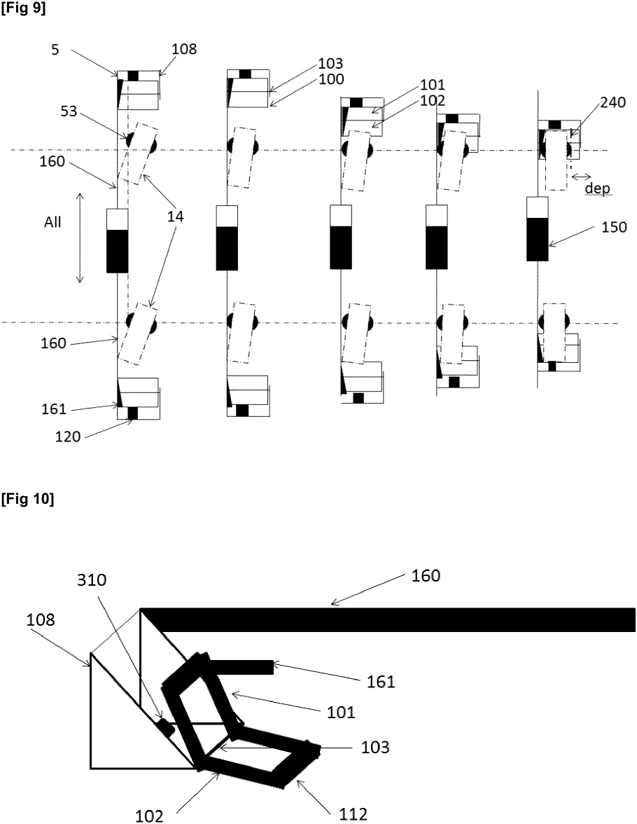

FIG. 9 schematically shows, by way of non-limitative example, different approach, gripping and lifting phases of the wheels of the rolling object.

The system comprises means 5 for coupling with two combined and simultaneous gripping and lifting means connected by an actuator 150 such as a cylinder allowing the combined and simultaneous gripping and lifting means to be moved closer to or away from one another.

Alternatively, without departing from the scope of the invention, the system can advantageously comprise two actuators, each actuator being connected on the one hand to the chassis and, on the other hand, to a combined and simultaneous gripping and lifting means, which notably allows to provide the necessary length of travel and to increase the separation speed of the two combined and simultaneous gripping and lifting means.

The diagrams from left to right show the combined and simultaneous gripping and lifting means progressively moving closer to one another so as to grip and lift wheels 14 of the rolling object whose wheelbase is fixed. These diagrams are shown in top view. The motion (translation) in the transverse direction of the combined and simultaneous gripping and lifting means is shown by the double arrow All.

The combined and simultaneous gripping and lifting means comprise each a frame 108 connected to an actuator 150. A tilt element 100 is connected to frame 108 by a pivot connection 103 of horizontal axis. Tilt element 100 consists of two parts 101 and 102 rigidly attached to one another, horizontal-axis pivot connection 103 being positioned at the rigid connection between the two parts 101 and 102.

Each wheel 14 of the rolling object is oriented around a vertical pin 53 that protrudes on each side of wheel 14. Thus, in the leftmost diagram, when the electric propulsion system is moved close to the rolling object (or vice versa), wheel 14 comes into contact with guide element 160 extending substantially in the transverse direction. Guide element 160 then causes wheel 14 to pivot around vertical pin 53 so as to be oriented in a direction close to the transverse direction, as in the second diagram from the left. Wheel 14 is not exactly in the transverse direction because the part of vertical pin 53 protruding from wheel 14 may hinder and thus prevent positioning of wheel 14 of the rolling object in the transverse direction.

In the third diagram from the left, wheel 14 of the rolling object comes into contact with tilt element 100, notably on part 102 of tilt element 100. Tilt element 100 comprises a guide piece 161 that guides wheel 14 of the rolling object in the combined and simultaneous gripping and lifting means, so as to position wheel 14 in a substantially transverse direction, perpendicular to the longitudinal direction of the chassis. Therefore, guide piece 161 comprises an inclined part forming a non-zero angle with the transverse direction in top view in order to gently guide wheel 14 in the desired direction while preventing jerks.

Between the third and the fifth diagram from the left, it is noted that wheel 14 guided by guide piece 161 is progressively oriented in the transverse direction. In the final position, on the right-hand diagram, wheel 14 of the rolling object is in contact with a first stop 120 fastened to frame 108.

Besides, a mobile flange 240 can be used to adjust the width of tilt elements 100 to the width of wheel 14 of the rolling object. Flange 240 can therefore move in the longitudinal direction, in a displacement dep, for example along pivot connection 103. Alternatively, shims could be used instead of the mobile flange, the shims being removable.

FIG. 10 schematically illustrates, by way of non-limitative example, a perspective view of a first embodiment of a combined and simultaneous gripping and lifting means according to the invention.

In this figure, the combined and simultaneous gripping and lifting means comprises a guide element 160 at the end of which a frame 108 is attached. A tilt element made of two parts 101 and 102, rigidly attached to one another and forming a non-zero angle, is positioned on this frame. The tilt element is therefore bent. In other words, the tilt element forms a tilter here. The tilt element is positioned on the frame on the same side as guide element 160. The tilt element pivots around a pivot connection of horizontal axis 103 connected to the frame, enabling rotation of the tilt element relative to the frame, pivot connection 103 being advantageously positioned at the link between the two plane parts 101 and 102. The tilt element allows gripping and lifting of the wheel of the rolling object to be performed in a simultaneous and combined manner.

Furthermore, a guide piece 161 positioned on the tilt element, on the same side as the guide element, allows the wheel to be oriented in the tilt element.

Additionally, a holding part 310 allows the tilt element to be supported when it supports the wheel of the rolling object so as to improve take-up of the forces involved and to limit fatigue of the tilt element. This holding part 310 can be advantageously positioned in the bottom of frame 108. According to a variant, holding part 310 positioned in the bottom of the frame could support wheel 14 of the rolling object. Holding part 310 is advantageously made of a flexible material (a material that can undergo a deformation of some millimetres at least when the wheel or the tilt element comes into contact) such as rubber.

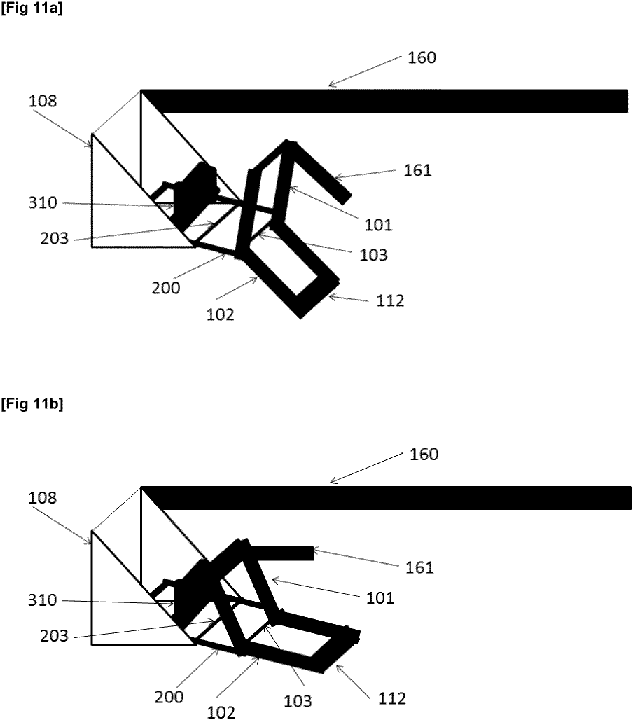

FIGS. 11a and 11b schematically illustrate, by way of non-limitative example, a perspective view of a second embodiment of a combined and simultaneous gripping and lifting means according to the invention.

In these figures, the combined and simultaneous gripping and lifting means comprises a guide element 160 at the end of which a frame 108 is attached. A second tilt element 200 made of two parts rigidly attached to one another, thus forming a bent piece, is positioned on this frame. This second tilt element 200 is positioned on frame 108 on the same side as guide element 160. This second tilt element 200 pivots around a pivot connection of horizontal axis 203 connected to frame 108, enabling rotation of second tilt element 200 relative to frame 108. A first tilt element in two plane parts 101 and 102 rigidly fastened to one another, thus forming a bent piece, is connected to second tilt element 200 by means of a second pivot connection of horizontal axis 103 parallel to pivot connection 203. The first tilt element comprises a support part 112 that comes into contact with the wheel of the rolling object. Support part 112 allows to support and to lift the wheel of the rolling object, notably as gripping of the wheel of the rolling object starts. The first and second tilt elements allow gripping and lifting of the wheel of the rolling object to be performed in a combined and simultaneous manner.

Furthermore, a guide piece 161 positioned on the first tilt element, on the same side as guide element 160, allows the wheel to be oriented in the tilt element.

Additionally, a holding part 310 allows the first tilt element to be supported when it supports the wheel of the rolling object so as to improve take-up of the forces involved and to limit fatigue of the first tilt element. Furthermore, this holding part 310 can allow second tilt element 200 to be driven in rotation. According to a variant, holding part 310 can support the wheel of the rolling object and drive second tilt element 200 in rotation.

In FIG. 11a, the first tilt element is in a position enabling easy contact with the wheel of the rolling object. This can correspond to the rest position of the combined and simultaneous gripping and lifting means.

In FIG. 11b, the first tilt element is in an intermediate position where it has tilted around its horizontal axis 103 without being in contact yet with holding part 310.

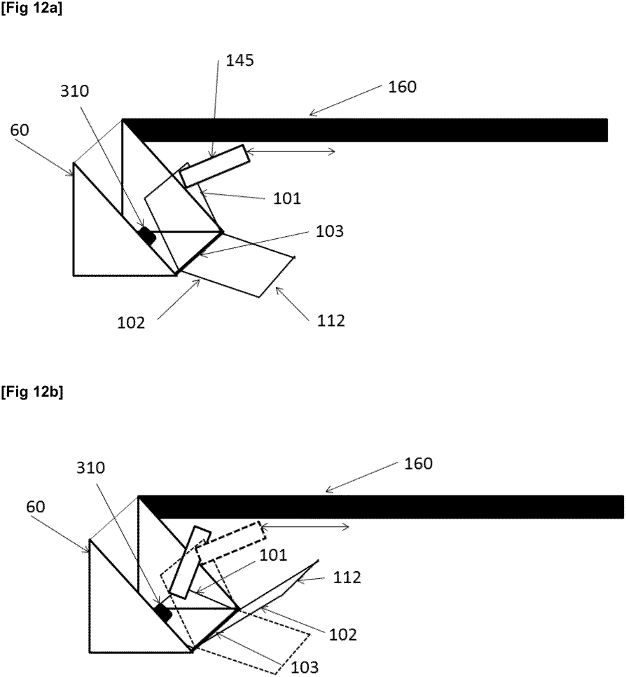

FIGS. 12a and 12b schematically illustrate, by way of non-limitative example, an embodiment of a device for raising a combined and simultaneous gripping and lifting means according to the invention.

In these figures, the combined and simultaneous gripping and lifting means comprises a guide element 160, the guide element extending in the transverse direction, at the end of which a frame 108 is attached. A tilt element made up of two parts 101 and 102, rigidly fastened to each other and forming a non-zero open angle, is positioned on this frame 108. The tilt element is positioned on the frame on the same side as guide element 160. The tilt element pivots around a horizontal-axis pivot connection 103 connected to frame 108, enabling rotation of the tilt element with respect to frame 108. The tilt element allows to simultaneously achieve gripping and lifting of the wheel of the rolling object. Pivot connection 103 is advantageously positioned at the link between the two parts 101 and 102.

In addition, a holding part 310 allows to support the tilt element when it supports the wheel of the rolling object so as to improve take-up of the forces involved and to limit fatigue of the tilt element. It also allows tilt element 200 to be driven in rotation. According to a variant, holding part 310 can support the wheel of the rolling object.

Furthermore, a cam 145 is rigidly fastened on the tilt element. At the end of the cam 145 that is not fastened to the tilt element, a displacement (translation) in the transverse direction (parallel to guide element 160) can be applied by a rod or a cylinder for example. This displacement is represented by the double arrow. When cam 145 is moved in the direction of frame 108, cam 145 causes the tilt element to be raised. The ground clearance is then increased. On the other hand, displacement of cam 145 in the opposite direction to frame 108 causes the tilt element to lower very close to the ground, thus facilitating gripping and lifting of the wheels of the rolling object. Displacement of cam 145 can be advantageously linked with an actuator that simultaneously allows to raise the tilt elements of two opposite combined and simultaneous gripping and lifting means.

Alternatively or in combination, a counterweight system could be used for raising the tilt elements.

FIG. 12a shows the tilt element in rest position, ready to grip and lift a wheel of the rolling object.

In FIG. 12b, the rest position is shown in dotted line and the raised position of the tilt element is shown in solid line. It can thus be noted that part 112 supporting the wheel, which is initially the lowest point, is raised and is therefore, in raised position, above pivot connection of horizontal axis 103.

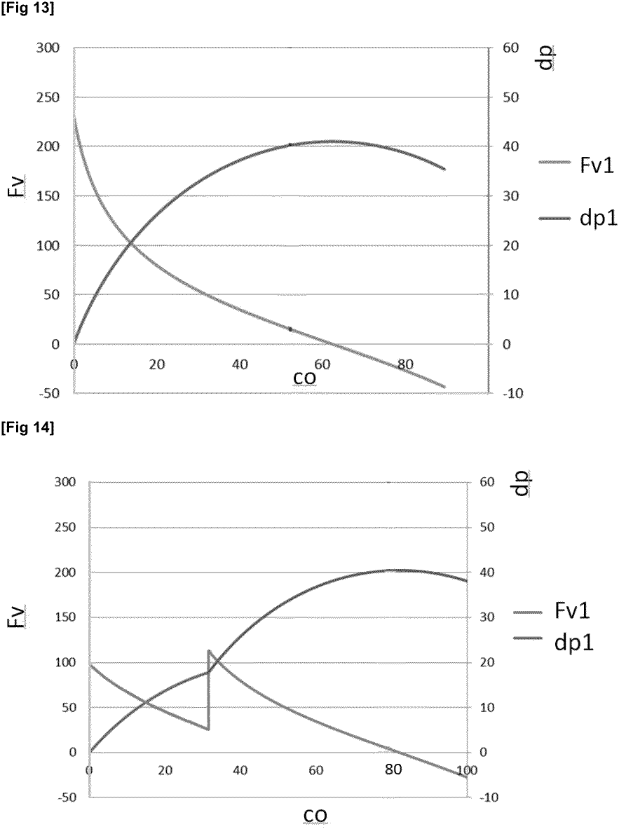

FIGS. 13 to 15 show the evolution of the force Fv applied by the cylinder(s) during the travel co (in the transverse direction) applied to the combined and simultaneous gripping and lifting means, the initial point of travel co corresponding to the first contact between the wheel of the rolling object and the first tilt element. Travel co occurs in the transverse direction of the propulsion system.

These figures also show the elevation of the wheel dp with respect to the ground during travel co.

Curve Fv1 shows the evolution of the force applied and curve dp1 that of the elevation of the wheel of the rolling object.

FIGS. 13 to 15 show the evolution of the force Fv1 applied and the evolution of the elevation of the wheel of the rolling object for three embodiments of combined and simultaneous gripping and lifting means according to the invention.

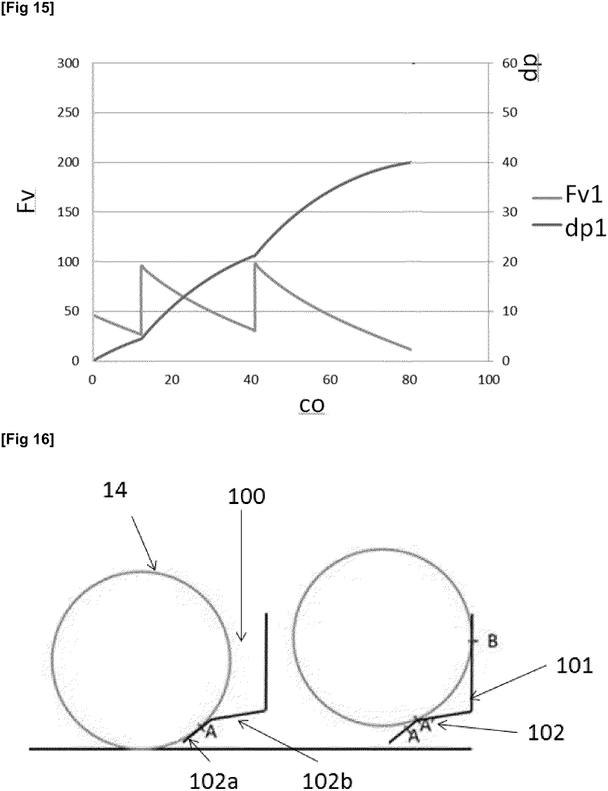

FIG. 13 illustrates the case of a system according to the invention with a single tilt element, FIG. 14 illustrates the case of a system according to the invention with two tilt elements and FIG. 15 illustrates the case of a system according to the invention with two tilt elements and a device for limiting the angular clearance of the first tilt element (the one coming first into contact with the wheel of the rolling object). The system of FIG. 13 corresponds to the embodiment of FIG. 5, the system of FIG. 14 to the embodiment of FIG. 6A and the system of FIG. 15 to the embodiment of FIG. 7B (wheel 14 tilting around contact point A until it comes into contact with point B).

These figures correspond to the gripping and lifting of a rolling object with a weight of approximately 400 N, i.e. substantially 100 N per wheel.

It is noted that, for the three systems, the elevation of the wheel is approximately 40 mm, which provides a sufficient ground clearance once the system coupled to the rolling object.

Besides, it is observed that the multiplication of tilt elements between FIG. 13 and FIG. 14 allows to considerably reduce the maximum force required (that decreases from over 200 N to less than 120 N). The maximum forces correspond to the times of first contact with each tilt element.

In FIG. 14, a first part is observed where force Fv1 decreases prior to suddenly increasing, then decreasing again. The time of this sudden increase corresponds to the time when the second tilt element tends to initiate the pivotal motion around its pivot connection.

In FIG. 15, it is observed that the effect of adding an angular clearance limiting device is similar to that of adding a tilt element. Indeed, between FIG. 14 and FIG. 15, the maximum force has decreased from approximately 120 N to less than 100 N. It is also observed that, at about 15 mm travel co, the effect of the angular clearance limitation generates a sudden increase in the force involved, in a manner similar to the effect observed when adding a tilt element. In other words, the angular clearance limiting device has a similar effect to that of the addition of a tilt element.

It is also noted that the addition of a tilt element and/or an angular clearance limiting device tends to create slight points of discontinuity on curves dp1 related to the beginning of the tilt of the various tilt elements.

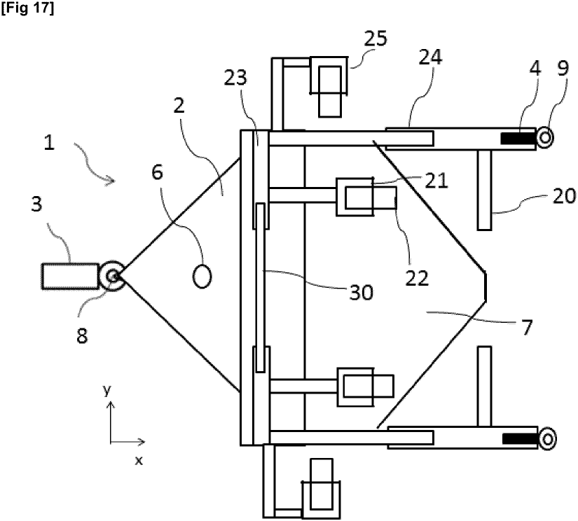

FIG. 17 schematically illustrates, by way of non-limitative example, an electric propulsion system 1 according to an embodiment of the invention. FIG. 17 is a top view of electric propulsion system 1. Electric propulsion system 1 comprises a chassis 2. Axis x corresponds to the longitudinal axis of chassis 2 and to the principal direction of travel of propulsion system 1, and axis y corresponds to the lateral axis of chassis 2 (axis z, not shown, is vertical). Chassis 2 supports, at one of the longitudinal ends of electric propulsion system 1, a wheel 3 (alternatively chassis 2 can have two wheels 3), which is a wheel driven by an electric machine (not shown). Wheel 3 is orientable relative to chassis 2, around a vertical axis 8. At the other longitudinal end of electric propulsion system 1, the electric propulsion system comprises two wheels 4, which are two wheels that are not driven by an electric machine. These two wheels 4 are off-centered wheels orientable around vertical axes 9. Electric propulsion system 1 further comprises coupling means.

According to the illustrated embodiment, the coupling means comprises two combined and simultaneous gripping and lifting means.

The first combined and simultaneous gripping and lifting means 25 allows to simultaneously grip and lift two wheels of the rolling object that are oriented in the perpendicular direction to longitudinal axis x, i.e. in transverse direction y.

The second combined and simultaneous gripping and lifting means comprises two parts, each part comprising a mount 23 and a tilt element 22, such as a tilter, connected to mount 23 by a pivot connection of transverse axis 21. Each part of the second combined and simultaneous gripping and lifting means also comprises a push device 20 connected to an extensible arm 24 in the longitudinal direction. The length of extensible arm 24 is therefore variable in the longitudinal direction. One end of this extensible arm 24 is attached to mount 23. Thus, extensible arm 24 allows to decrease or to increase the longitudinal distance between third tilt element 22 and push device 20 so as to position a wheel of the rolling object between these two parts, then to push the wheel into third tilt element 22. Extensible arm 24 can notably comprise a cylinder for controlling lengthening or shortening of extensible arm 24. Non-driven wheels 4 are mounted by means of vertical pin 9, at the longitudinal end opposite the end connected to mount 23, of each extensible arm 24. Thus, the distance between non-driven wheels 4 and chassis 2 can vary. The position of non-driven wheels 4 on extensible arm 24 allows to improve take-up of the forces once the rolling object coupled to electric propulsion system 1.

In order to increase and to decrease the distance between mounts 23 (and thus to provide the transverse distance of third tilt elements 22 relative to one another and of push devices 20 relative to one another), the two mounts are connected by a sliding connection of transverse direction 30. This function can for example be fulfilled by a cylinder or by a rack. The coupling means is arranged, in direction x, between motorized wheel 3 and orientable off-centered wheels 4.

The second combined and simultaneous gripping and lifting means simultaneously enables gripping and lifting of two wheels of the rolling object that are oriented in longitudinal direction x.

In addition, electric propulsion system 1 comprises a handlebar 6, for example in form of a rod equipped with a handle (not shown).

Besides, electric propulsion system can comprise a supporting platform 7 (for supporting a user for example).

The propulsion system of the invention is notably suitable for different rolling objects, with different wheel gauges and different wheel diameters. It therefore provides a great variability of use.

1. A removable electric propulsion system (1) for a rolling object (13), said propulsion system (1) comprising a chassis (2) provided with at least one wheel (3) driven by an electric machine (10) and at least one non-driven wheel (4), said electric propulsion system (1) comprising at least one means (5) for coupling said electric propulsion system (1) to said rolling object (13), characterized in that said coupling means (5) comprises two means (20) for combined and simultaneous gripping and lifting of wheels (14) of said rolling object (13), connected to each other by an actuator allowing the combined and simultaneous gripping and lifting means to be moved closer to or away from one another.

2. A system as claimed in claim 1, wherein at least one of said combined and simultaneous gripping and lifting means (20) comprises at least one frame (108) connected to chassis (2) and at least one tilt element (100) capable of supporting wheel (14) of rolling object (13), said frame (108) being connected by a first pivot connection (103) of substantially horizontal axis to at least one tilt element (100).

3. A system as claimed in claim 2, wherein at least one of said combined and simultaneous gripping and lifting means (20) comprises at least two tilt elements (100, 200), said tilt elements (100, 200) being connected to each other, two by two, through substantially horizontal and parallel pins (103, 203).

4. A system as claimed in claim 2, wherein at least one of said combined and simultaneous gripping and lifting means (20) comprises at least one device (230, 300) for limiting the angular clearance of at least one tilt element (100, 200).

5. A system as claimed in claim 2, wherein at least one of said combined and simultaneous gripping and lifting means (20) comprises at least one piece (110, 310) for holding at least one tilt element (100, 200) in raised position.

6. A system as claimed in claim 2, wherein at least one tilt element (100, 200) comprises a guide piece (161) for orienting wheel (14) of rolling object (13) in said tilt element (100, 200) comprising said guide piece (161).

7. A system as claimed in claim 2, wherein at least one tilt element (100, 200) comprises a means (240) for adjusting the width of said tilt element (100, 200), said means (240) for adjusting the width of said tilt element (100, 200) being preferably a mobile flange or a shim.

8. A system as claimed in claim 1,
wherein at least one of said combined and simultaneous gripping and lifting means (20) is configured to simultaneously achieve gripping and lifting of at least two wheels (14) of rolling object (13), said at least two wheels (14) of rolling object (13) being preferably positioned on a substantially transverse axis to said electric propulsion system (1).

9. A system as claimed in claim 1,
wherein at least one of said combined and simultaneous gripping and lifting means (20) comprises at least one means enabling movement in the transverse direction of said combined and simultaneous gripping and lifting means (20), the transverse direction being orthogonal to the longitudinal direction (x), longitudinal direction (x) being the principal direction of travel of said removable electric propulsion system (1).

10. A system as claimed in claim 1,
wherein at least one of said combined and simultaneous gripping and lifting means (20) comprises a guide element (160) for orienting wheel (14) of rolling object (13) in a direction close to a substantially perpendicular direction to longitudinal direction (x) of said chassis (2) of said propulsion system (1), before said wheel (14) of rolling object (13) is gripped and lifted.

11. A system as claimed in claim 1,
wherein at least one of said combined and simultaneous gripping and lifting means (20) comprises a first stop (120, 220) for immobilizing rolling object (13).

12. A system as claimed in claim 1,
wherein at least one of said combined and simultaneous gripping and lifting means (20) comprises a raising device configured to ensure a ground clearance greater than a predetermined height in raised position, preferably the predetermined height being at least 40 mm.

13. A system as claimed in claim 12, wherein the raising device comprises at least one return spring and/or at least one counterweight and/or at least one driven rod.

14. A system as claimed in claim 1,
wherein at least one of said combined and simultaneous gripping and lifting means comprises an adjustment means in longitudinal position.

15. A system as claimed in claim 1,
wherein said coupling means comprises two combined and simultaneous gripping and lifting means, a first combined and simultaneous gripping and lifting means (25) being configured to grip and lift at least one wheel of the rolling object oriented in the transverse direction, and a second combined and simultaneous gripping and lifting means being configured to grip and lift at least one wheel of the rolling object oriented in a longitudinal direction.

16. A system as claimed in claim 15, wherein said second combined and simultaneous gripping and lifting means comprises a mount (23), at least one arm (24) extensible in a longitudinal direction (x), connected to mount (23), at least a third tilt element (22) and at least one push device (20), said third tilt element (22) and push device (20) being connected, for one, to said extensible arm (24), and the other to mount (23), said push device (20) being suited to push at least one wheel of the rolling object in said longitudinal direction (x) into said at least third tilt element (22), said third tilt element (22) being suited to tilt around an axis of substantially transverse direction (21).

17. A coupled assembly comprising a rolling object (13) and an electric propulsion system (1) as claimed in claim 1, said rolling object (13) being coupled to said electric propulsion system (1) by said coupling means (5).

18. A method for coupling a rolling object (13) to electric propulsion system (1) as claimed in claim 1, comprising the following steps:
a) moving electric propulsion system (1) longitudinally so as to bring at least one of said combined and simultaneous gripping and lifting means (20) close to at least one wheel (14) of rolling object (13),
b) moving combined and simultaneous gripping and lifting means (20) or electric propulsion system (1) in the transverse direction so as to enable contact between wheel (14) of rolling object (13) and combined and simultaneous gripping and lifting means (20), and
c) continuing the motion in the transverse direction so as to enable combined and simultaneous gripping and lifting of at least one wheel (14) of rolling object (13).
